(19) United States
(12) Patent Application Publication
(10) Pub. No.: US 2013/0212942 A1
(43) Pub. Date: Aug. 22, 2013

(54) PLANT FEEDING ASSEMBLY

(71) Applicant: Norman Plummer, Buckingham (GB)

(72) Inventor: Norman Plummer, Buckingham (GB)

(21) Appl. No.: 13/813,184

(22) PCT Filed: Jul. 29, 2011
(86) PCT No.: PCT/GB2011/001140

§ 371 Date: Apr. 10, 2013

(30) Foreign Application Priority Data
Jul. 30, 2010 (GB) 1013108.4
Oct. 24, 2010 (GB) 1019869.5
Feb. 25, 2011 (GB) 1103231.5

(51) Int. Cl. A01G 27/06

(52) U.S. Cl. CPC A01G 27/06
USPC 47/66.6

(57) ABSTRACT

A plant feeding assembly comprising of at least two sub assemblies, one a reservoir (23) which feeds liquid to liquid transfer material (18) held by a metering plate (15) in group positions which conform to a feed pattern, the groups are represented by radial symbols (19), second is a plant pot (13) holding liquid transfer material in its base which transfers liquid from the outside to the inside of the pot (13), the transfer positions are collectively identified by an indicator, and concur with the feed pattern held by the metering plate (15). When a large volume of liquid is required for extended periods, a sleeve (14) having an inlet orifice (22) is placed in a container of liquid (23), the flow of liquid into the sleeve (14) is controlled by a float valve, and the reservoir created feeds liquid transfer material (18) held by a metering plate (15) which in turn supports the plant pot which nestles within the sleeve (14).

### CROSS REFERENCE TO RELATED APPLICATIONS

This application is the U.S. national stage of International Application No. PCT/GB2011/001140, filed on Jul. 29, 2011, and claims the benefit thereof. The international application claims the benefits of the applications GB 1013108.4 filed on Jul. 30, 2010; GB 1019869.5 filed on Oct. 24, 2010; and GB 1103231.5 filed on Feb. 25, 2011; all applications are incorporated by reference herein in their entirety.

### BACKGROUND

Generally the advice given for plant care is “Do not over water, Keep moist to the touch, water from the top, water from the bottom”. This uncertain use of liquid leads to waste and incorrect plant care. The correct amount of liquid needed for plant care in pots or containers is in general difficult to assess, this is primarily due to the necessity to provide drainage holes in the base of the plant container to allow excess liquid to drain away in order to stop saturation of the planting medium. In some cases the holes are used in a reverse way by allowing the plant pot to stand in liquid which is replenished when needed, this procedure may give rise to saturation because of the assumption that the more volume of liquid feed equates to longer time intervals between replenishment.

### DETAILED DESCRIPTION

The present invention does not include any drainage facility; the liquid feed is continuously delivered in selected minuscule volumes to the planting medium according to the radial differential setting between the liquid storage container and the plant container, this facility promotes the well being of the plant and promotes conservation of liquid.

One aspect of this invention is that by rotating the plant container sub-assembly relative to the liquid container sub-assembly, the volume of liquid offered to the planting medium can be increased or decreased from zero to the design maximum, the volume of liquid is delivered in minute quantities, the moisture content of the planting medium is kept at a constant level set by the selected radial differential between the two sub-assemblies.

Another advantage of having to sub assemblies is the facility of inter changeability between compatible plant containers and metered liquid supply systems without altering either the volume of feed or the incremental feed, this enables large stockists of plants such as nurseries, supermarkets etc. to have a static or mobile liquid containers such as tanks, trays, units with multiple feed outlets from which a single plant container can be transferred to a single feed system whilst retaining the same feeding programme.

Using the present invention the amount of liquid being used by the plant is quantifiable, also the point of delivery within the plant container can be selected, therefore the results of the propagation can be accurately recorded, repeated and passed on. This is important when the suppliers are relating to customers and also for the exchange of data between professional colleagues.

Little knowledge for the care of plants is being transferred from informed bodies to lay people because of the present inaccurate method of plant feeding, this invention sets out to solve this by documenting the following details, plant container size, module number (Denoting transfer characteristics) metering plate design and liquid settings. The application and use of this technology is accurate, timesaving, and conducive to water conservation.

The liquid storage container holds a metering plate in a fixed position above the maximum level of liquid that can be stored by the container, the metering plate holds liquid transfer material so that pads of specific area and location are formed on its top face, with the remainder suspended below in a position where it is able to take up liquid retained within the container, the position of each pad is identified by a symbol on the outer circumference of the container, the collective number of pads and their radial positions conform to a pre determined feed pattern.

The plant container has no drainage holes in its base, liquid transfer material called modules are inserted into the base so that pads are formed on the outside whilst the remainder is retained within the plant container, and the exposed pads are positioned according to a feed pattern established on a complimentary metering plate. The total group position of the exposed pads are recorded on the side of the plant container by an indicator; liquid transfer from the modules to the planting medium is inhibited, by placing insulating sleeves over the modules.

Assembly of plant container and liquid storage container. The plant container is positioned on the metering plate which is held by the liquid container, transfer of liquid occurs between the pads of the liquid transfer material located on the metering plate with modules held by the plant container when two units are contra rotated to produce an alignment between the indicator on one unit with one of the radial marks on the other unit, the various radial differentials indicate the area of contact of liquid transfer material held by the two units.

The availability of large volumes of liquid feed. When extended intervals between the feeds are required the liquid container as described previously is replaced by the following.

A metering plate holding liquid transfer material is positioned inside a sleeve so that liquid in the base of the sleeve can be taken up by liquid transfer material held by the metering plate and transferred to the top face of the metering plate, the support and radial location of the metering plate within the sleeve can take various forms such as being an integral part of the sleeve, a restriction within the sleeve at the support location also by a supporting structure located under the metering plate, an orifice in the base of the sleeve allows liquid to enter the sleeve. When the sleeve is placed in liquid retained within a bulk liquid container, the flow of liquid through the orifice is controlled by a float valve comprising of a lever which pivots on a spindle supported by pillars emanating from the base of the sleeve, at one end of the lever is a float which responds to the level of liquid in the sleeve, at the other is a resilient pad which monitors the inflow of liquid into the sleeve in response to the action of the float the valve shuts off the flow of liquid before it reaches the metering plate, any suitable material can be used for a float, examples are, one piece plastic that is impervious to liquid, volume of gas trapped within an outer structure.

Another method of controlling the inflow of liquid into the sleeve is a one piece unit which consists of a rigid beam section that holds a float at one end and a resilient pad at the other, extending from the under face of the beam is a flexible section which connects to a rigid base, this base is fixed to the base of the sleeve, the flexible centre section allows the beam to rock whilst the base section is static. This action is used to monitor the inflow of liquid into the sleeve in response to the position of the float.

A plant container retaining liquid transfer modules is offered into the sleeve until it rests on the metering plate, in this position the lip of the plant container is just proud of the top sleeve, graduation marks on the rim of the sleeve indicate the angular position of the contact pad formed on the metering plate, an indicating mark on the rim of the plant container indicates the group position of the modules held by the plant container, various positions of alignment between the liquid transfer material held on the metering plate and the plant container modules are obtained by the contra rotation of two units.

In cases where it is found necessary to stabilise the sleeve and plant container within the bulk liquid container, because of the destabilising buoyancy of the liquid, the following are some of the methods that can be used, extra weight can be added to the sleeve, the sleeve and bulk liquid container conjoined, a suction is created between bulk liquid container and sleeve, the bulk liquid container can take any form such as a domestic plant pot, tray or tank etc. The level of liquid held in the bulk container must always fall short of the top rim sleeve. On large assemblies rollers are introduced between the plant container and sleeve, to transfer the weight of the plant container and contents onto the sleeve, the metering plate is sprung so the liquid transfer material held on the metering plate and modules in the plant container engage, the radial position of the metering plate relative to the indicating symbols on the sleeve is held constant. One of the advantages of using a bulk liquid container is that chemicals fed into the liquid are delivered in a homeopathic manner over an extended period. When liquid consumed by a plant needs to be documented the following may be use, an external transparent tube emanating from inside the container to the outside, a vertical section of the container being transparent, an electronic liquid censor etc.

When the present invention is used in a situation where it is exposed to rain, contamination of the liquid feed system is prevented by a covering which deflects the water away from the planting medium; it may be directed into the bulk liquid container in which the sleeve is placed, when the bulk liquid container is full excess water may be retained by a second bulk liquid container which may take the form of a plinth supporting the liquid container and plant assembly, this liquid can be used to top up the bulk liquid container holding the sleeve and plant using a powered recycling system.

One advantage of this practice is the reduction of time needed for the care of plants such as when floral tributes are placed on memorials. Planting mediums not exposed to rain need only a covering to protect it from incorrect feeding or evaporation which would give incorrect data when documenting volume of feed consumed, to, variation in plant growth.

Liquid containers for the construction of terraces and tier systems can be of any suitable size or shape, these containers hold multiple liquid feed outlets which can receive compatible plant containers, the liquid containers are positioned so that excess liquid from one container drains down via an overflow pipe or baffle to a lower container, liquid in the top container may be supplied from a collecting canopy, mains, tank, a powered re-circulatory loop system which recycles the overflow from the bottom container to a higher container etc. or, a combination of any the above systems, the recycling may be powered, by solar, wind or any other source of energy, the lowest tank has an overflow outlet, the metering plates holding liquid transfer material may be an integral or composite part of the liquid container, an example of a tier assembly is when one tank is situated directly above the one below.

Volumes of liquid used over an approximate time intervals two examples are tabulated below giving the approximate time taken for a plant to consume a fixed volume of liquid.

The first example is using a liquid storage container which is directly supporting a plant container:
Pot Size=120 ml
Volume of liquid consumed is equal to 0.5 L

Approximate consumption time +2 weeks

The second example is when bulk liquid container is used to replenish a small volume of liquid from which the liquid from which the liquid transfer material is fed.
Pot size=180 ml
Volume of liquid consumed=4 L

Approximate consumption time +2 months

Liquid transference is uncertain when a plant container which has drainage holes in its base is placed on saturated capillary matting for feeding purposes, because of the lack of direct contact between the matting and the planting medium, positive transfer of liquid is achieved by inserting or covering the drainage hole with a plug which holds a liquid transfer module as described in this invention.

### DETAILED DESCRIPTION OF THE PREFERRED EMBODIMENT

Drawing 1/5, FIG. 2, liquid container 2 has incremental markings 3 around its circumference which have a fixed relationship with protruding lip 5, metering plate 7 is radially located by protruding tag 6 nestling in lip 5, and supported by container 2, slots which transgress through metering plate 7 have fixed radial relationships with protruding tag 6, they also conform to a specific geometric design according to the required liquid delivery specification, these slots hold liquid transfer material 8 so as to create contact areas on its upper face whilst the remaining liquid transfer material 8 has access to liquid below metering plate 7, various increments of feed can be designed into the metering plate 7 and complimentary plant pot 1.

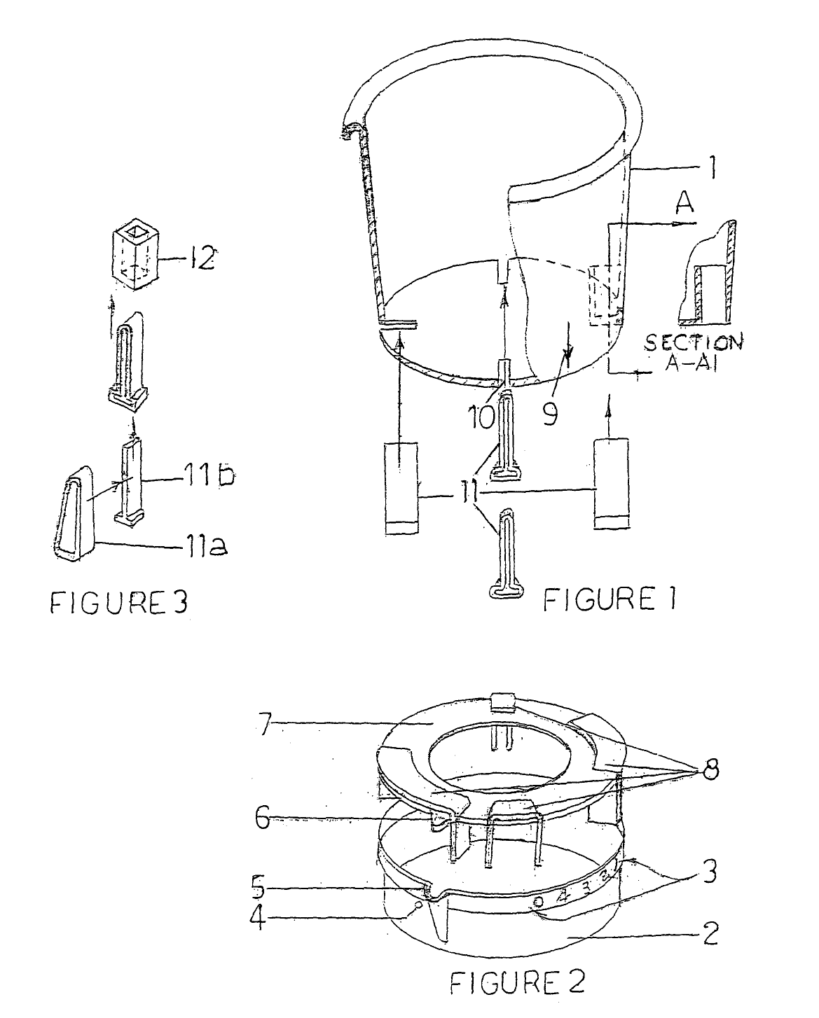

Plant container 1, FIG. 1 has at least one aperture 10 able to take modules 11 in its base, the number of modules retained depends on the number of increments that the liquid delivery specification is divided into, it is complimentary to the design of metering plate 7, FIG. 2 holding the liquid transfer material 8. Apertures 10 have a fixed group radial relationship to indicating mark 9 on the circumference of the plant container 1, the function of these apertures is to locate and retain modules 11 which acts to transfer liquid from the exterior to the interior of plant container 1.

FIG. 3, the modules can be of a mono form or a composite assembly as shown in exploded view FIG. 3, the liquid transfer material 11 a is supported by a semi ridged structure 11 b which can be formed so as to reach required areas of the planting medium inside plant container 1, FIG. 2. There are many ways of masking liquid transfer material to stop the transfer of liquid from the module to the planting medium, some of which are tabulated below. A tube, 12 of non absorbent material which may have perforations which can be placed over module 11, the application of liquid insulating coating, as a integral part of the plant pot as shown by cross section A-A1 FIG. 1, Drawing 1/5.

An example, when one volume of liquid is required, with an off position there would be one liquid transfer pad 8 on the metering plate 7 and one module 11 held by the plant container 1, by contra rotation of container 2 and plant container 1 an off on function is obtained, incremental marks 1 and 0 would be on the circumferences of container 2.

There are various feed systems that can be designed into metering plate 7 and complimentary plant container 1, a schematic example of a design layout for a 4 stage feed delivery system together with an off position is shown in exploded form in Drawing 1/5 and is as follows:
Station 0—no plant pot modules in contact
Station 1—1 plant pot module in contact
Station 2—2 plant pot modules in contact
Station 3—3 plant pot modules in contact
Station 4—4 plant pot modules in contact

These stations are gained by the contra rotation of the plant container assembly FIG. 1 and liquid container assembly FIG. 2, using marks 3 on the liquid container and mark 9 on the plant pot 1 for alignment.

The contact areas (denoted in units) of the four liquid transfer pads held by the metering plate in the above example is as follows:
1 Pad of 1 unit area
1 Pad of 2 unit area
1 Pad of 3 unit area
1 Pad of 4 Unit area

Reference is Now Made to Drawings. 1/5, 2/5 and 4/5:

When a stored volume of liquid larger than that held by the container 2, FIG. 2, drawing 1/5 is required, the design as shown in Drawing 2/5 is used, and is as follows:

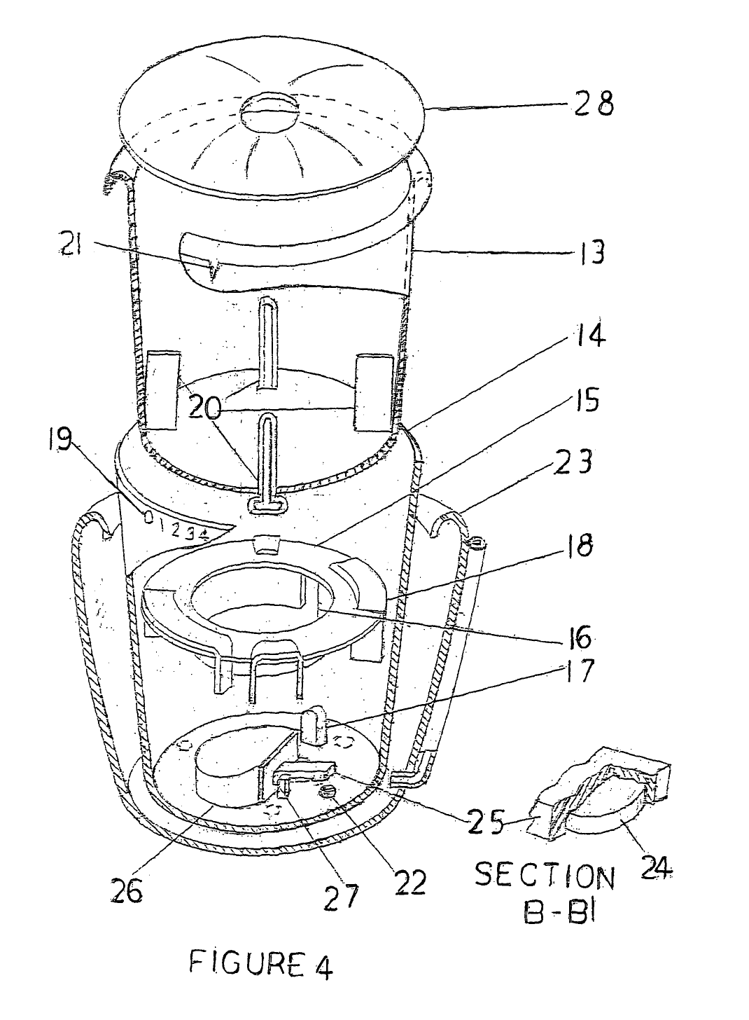

FIG. 4, Plant container 13 is located within a nestling sleeve 14 which has one end closed and the other end open to receive plant container 13. Metering plate 15 is supported by an extension from its underside which contacts the bottom of the sleeve 14, on assembly, it is radially located by interlocking recess 16 with projection 17 in the base of the sleeve, this fixes the radial position of the liquid transfer material 18 held by the metering plate 15, to the incremental markings 19 on sleeve 14, the parts of the liquid transfer material 18 exposed on the top surface on the metering plate 15 can engage with exposed sections of modules 20 on the base of the plant container 13 on assembly, the free ends of the liquid transfer material 18 gain access to the chamber between the metering plate 15 and the base of sleeve 14, when plant container 13 is assembled in sleeve 14 it is free to rotate relative to sleeve 14 whilst being confined laterally, mark 21 has a fixed radial position relative to the positions of modules 20. When 21 is aligned with one of the marks in group 19 it will indicate the area of contact between the liquid transfer material 18 held by the metering plate 15 and modules 20.

An inlet orifice 22 in the lower chamber of the sleeve 14 allows liquid to enter when sleeve 14 is immersed in a bulk liquid container 23, this example being a household vase, other cases may be of an industrial nature, such as a deep tray, tank or mobile unit etc. which could hold multiple pots as in FIG. 8, item 46 Drawing 4/5.

A metering valve controls the level of liquid in sleeve 14 to below the level of the metering plate 15, when in assembled position, the valve consists of a resilient pad 24 held above the inlet orifice 22, pad 24 is located at one end of lever 25, situated at the opposite end is a float 26, the fulcrum of lever 25 is a spindle held by pillars 27 extending internally from sleeve 14, lever 25 has a horizontal slot extending from the spindle bearing which enables it to be dislocated from the spindle leaving the spindle in place.

When the invention is exposed to rain, a cover 28 is necessary to deflect it from the planting medium in order to prevent contamination of the metering system, this cover can be of any suitable design and material such as an integral part of plant container 13, a solid covering lid 28, waterproof sheet, film which may be sprayed on, or canopy etc., the deflected rain is fed into the bulk liquid container 23, the overflow from this container may drain down into a holding vessel which may take the form of a plinth supporting container 23, alternatively it may be an integral part of container 23, this liquid may be recycled back to container 23 on demand by a censored pump which may be powered by solar, wind or any other sources of energy.

Planting medium not exposed to rain needs only a cover to protect it from incorrect watering or evaporation which would give incorrect data when equating plant performance to liquid feed used.

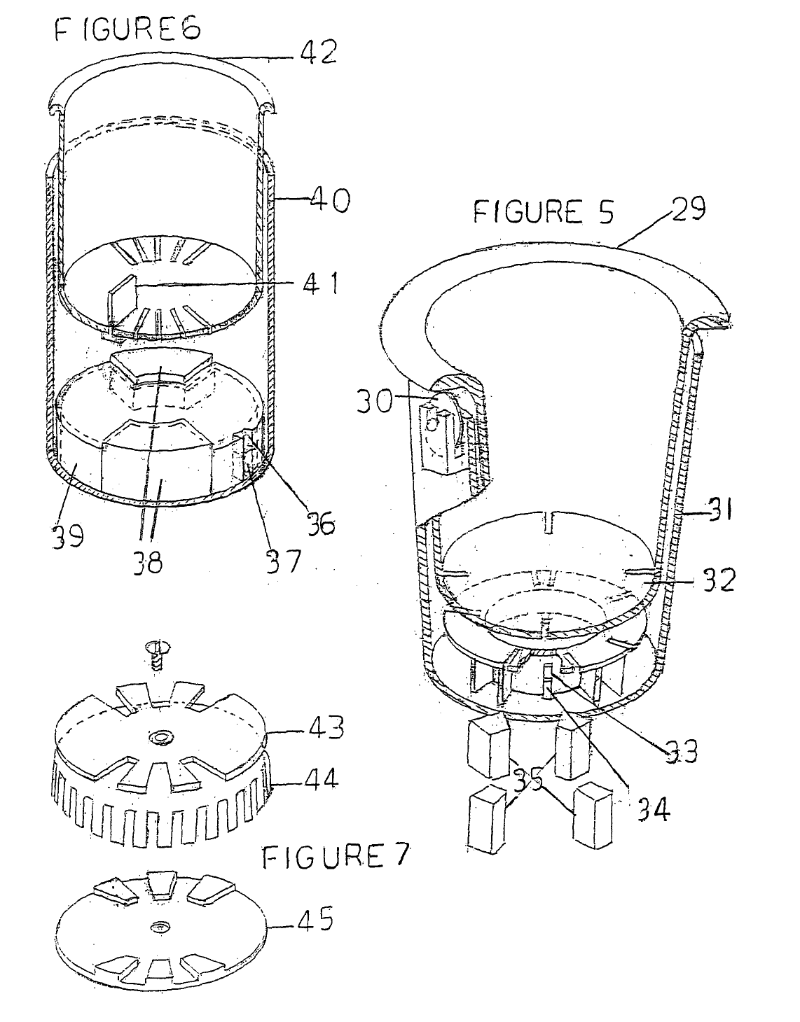

Reference is now made to drawing 3/5 FIG. 5, when the invention is used for heavy and large plant containers 29, rollers 30 are introduced between plant pot 29 and sleeve 31, the mountings for these rollers can be an integral part of sleeve 31, this design is adopted in order to transfer the weight of the plant container and planting medium onto the sleeve thus reliving the pressure on the liquid transfer materials held by metering plate 32 which is a vertical slide fit in the sleeve 31, it is located radially by slot 33 locating with lug 34 protruding from inside the base of sleeve 31. Metering plate 32 is sprung vertically by resilient pads 35 located on the underside of metering plate 32 this enables contact between the liquid transfer material held by metering plate and plant container, other methods of loading the metering plate may include other types of springing devices.

Reference is now made to FIG. 6: Hollow housing form 39 is positioned at the bottom of sleeve 40, it can be an integral part of sleeve 40 or a composite part which is radially located by slot 36 engaging with locating spigot 37, blocks of liquid transfer material 38 are located by housing 39, the number of blocks located and area exposed for contact with modules 41 held by plant container 42 depends on the selected feed pattern. FIG. 6 shows a five station feed pattern with an on off position; the modules are located in an equal incremental pitch arrangement.

FIG. 7 shows an alternative method of forming liquid transfer material 44 in pad form on the top face of metering plate 43, liquid transfer material 44 is sandwiched between metering plate 43 and embossed plate 45, on assembly the embossed projections on 45 direct liquid transfer material 44 into apertures in metering plate 43, the liquid transfer material 44 overlaps the edge of plate 45 and hangs down into the liquid container.

Reference Drawing 4/5: Item 46 is a terraced assembly of three liquid containers 47,49,51 which have multiple feed outlets 56 for receiving plant containers, the liquid containers 47,49,51 are arranged so that excess liquid received by 47 drains down via overflow 48 into container 49, the liquid overflow from this container drains into container 51, via overflow 50, overflow 55 exits excess liquid from container 51, this overflow may be recycled back to container 47, using powered return system, liquid supply to the top container 47 can be obtained by collecting rain using canopy 53, guttering 52 and down pipe 54 or any other liquid supply.

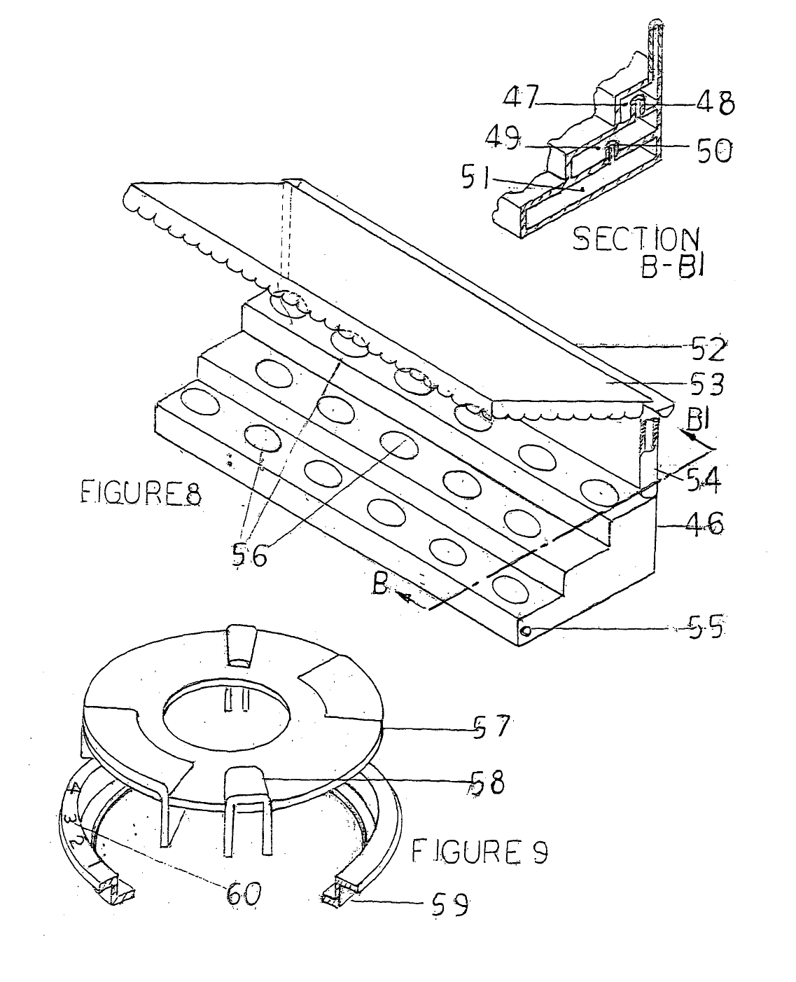

Reference FIG. 9 Metering plate 57 holding liquid transfer material 58 is held in a fixed radial relationship with adaptors 59 which locates the plant containers and has incremental feed symbols 60 around its perimeter, part 57, 58 59 are assembled and housed in apertures 56, when adaptor rings 59 are not used the metering plates are located in fixed radial positions below aperture 56 which are used as nests for holding plant containers, also incremental feed symbols are positioned around apertures 56. An arrow indicating feed as shown in FIG. 1, item 9, Drawing 1/5 is present on plant containers used for this system.

Reference Drawings 5/5.: FIG. 10 rigid section 61 holds at one end a resilient pad 62 on its lower face, at the other end a nest 63 which holds float 64, a reduced flexible section 65 connects 61 to base section 66 which attaches the whole to the base of the sleeve 14, Drawing 2/5. Section 61, 63, 65 and 66 are one piece.

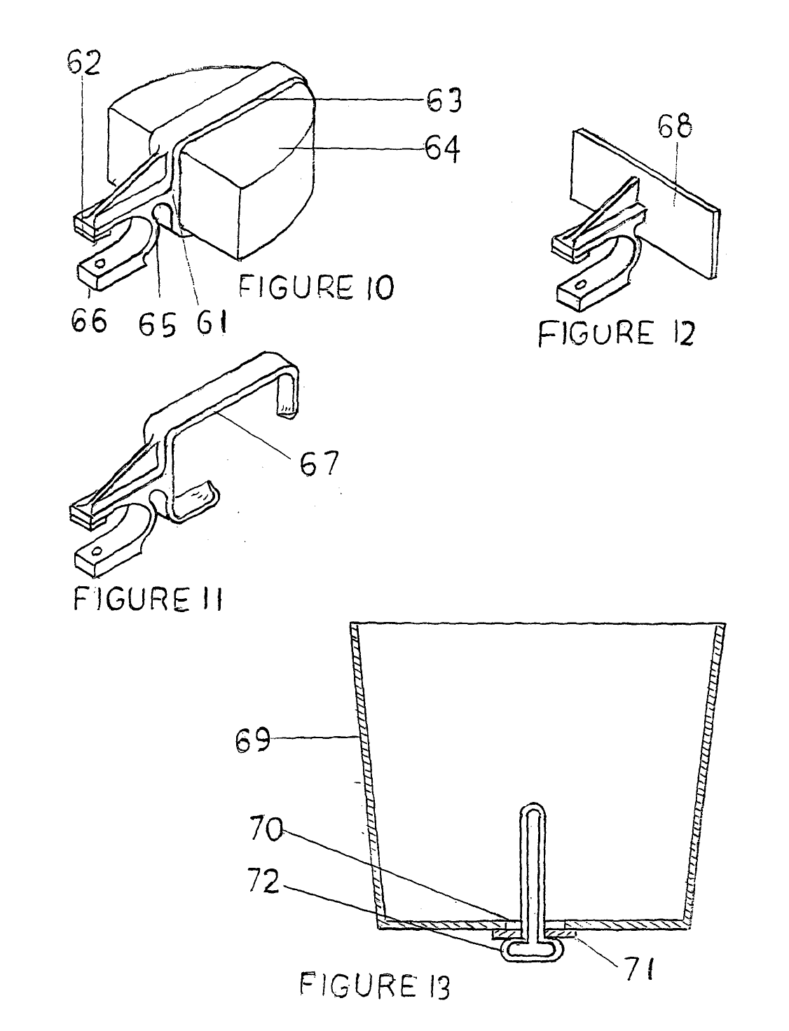

FIG. 11: clip 67 is an alternative to 63; it provides a nest and gripping function for the retention for float 64.

FIG. 12: is an alternative to the retaining functions of 63 and 67, it provides a surface 68 to which a float can be affixed, it can also be used as one section of a gas filled float.

When one of the levers shown in FIG. 10,11 or 12 is loaded with a float and anchored to the base of sleeve 14, Drawing 2/5 it will respond to the varying levels of liquid within the sleeve, this will cause pad 62 to rise and fall, thus controlling the level of liquid into the sleeve.

FIG. 13: shows a plant container 69 which has a drainage hole 70 in its base, blanking piece 71 retains module 11, FIG. 1, Drawing 1/5, so that when 71 and 11 are placed in situ covering hole 70, module 11, it is in a position of being inside and outside the plant container 67 which results in positive feed.

What is claimed:

1. A plant feeding assembly comprising at least two sub assemblies, one a liquid container assembly, the other a plant container assembly which when conjoined can be contra rotated to align an indicating mark on the one assembly with one of the symbols on the other indicating the area of contact of liquid transfer material between the two sub assemblies, the liquid container assembly comprising a metering plate which has apertures which hold liquid transfer material in positions according to a planned feed pattern.

2. A plant feeding assembly according to claim 1, wherein the plant container assembly has at least one aperture in its base, to retain liquid transfer material in positions of concurrence with the feed pattern of liquid transfer material present on a compatible metering plate.

3. A plant feeding assembly according to claim 1, wherein a liquid insulating material is provided to be applied to liquid transfer material in order to stop liquid transference.

4. A plant feeding assembly according to claim 1 in which a liquid container has the means to support and locate the metering plate.

5. A plant feeding assembly according to claim 1 in which a metering plate has apertures which hold liquid transfer material in positions according to a planned feed pattern.

6. A plant feeding assembly according to claim 1 in which symbols are displayed on the liquid container indicating the various positions of liquid transfer material offered for contact with a compatible plant container.

7. plant feeding assembly according to claim 1 in which liquid transfer material transposes liquid from the liquid container to areas on top of a metering plate which concur with the nominated feed pattern.

8. A plant feeding assembly according to claim 1 in which an aperture in the feed container allows liquid to escape.

9. A plant feeding assembly according to claim 1 in which a plant container has at least one aperture in its base, to retain liquid transfer material in positions of concurrence with the feed pattern of liquid transfer material present on compatible metering plate.

10. A plant feeding assembly according to claim 1 in which liquid transfer material is formed into contact pads on the exterior base of the plant container and then progresses to specific locations within the plant container, the contact areas and positions of the liquid transfer material held by the plant' container correlates to pads of liquid transfer material held on a compatible metering plate and to the design requirements of the feed pattern

11. A plant feeding assembly according to claim 1 in which support structure is used to stabilise and direct liquid transfer material inside the plant container.

12. A plant feeding assembly according to claim 1 in which a sleeve of impervious material which may have venting apertures, is used to mask the transfer action of the liquid transfer material held within the plant pot.

13. A plant feeding assembly according to claim 1 in which an indicator or symbols on the plant container identifies the radial group position of the liquid transfer material held by the plant container, and to facilitate the alignments of the plant container assembly and the liquid feed assembly.

14. A plant feeding assembly according to claim 1 in which a deflecting shield is used on top of the exposed area of the planting medium, extending from the base of the plant to just behind the outer rim of the plant container in order to deflect the rain.

15. A plant feeding assembly according to claim 1 in which a sleeve having a closed end retains a plant pot assembly and also a liquid metering system for maintaining a specific quantity of liquid in the base of the sleeve, when the sleeve assembly is placed in a volume of liquid.

16. A plant feeding assembly according to claim 1 in which an orifice is positioned in the sleeve assembly below the metering plate which allows liquid to enter from an outside source.

17. A plant feeding assembly according to claim 1 in which a filter is mounted on the intake side of the orifice.

18. A plant feeding assembly according to claim 1 in which a lever is pivoted on a spindle, one end of the lever retains a resilient pad which is able to restrict the influx of liquid into the sleeve, at the other end is a float which responds to the level of liquid in the chamber.

19. A plant feeding assembly according to claim 1 in which the inflow of liquid is controlled by a one piece unit having three sections of different functions, the base section has the function of anchoring the whole unit, the second section is a rigid beam which has a structure that holds a float at one end and at the other a resilient pad, the third section which is flexible, conjoins the rigid arm section and the base section.

20. A plant feeding assembly according to claim 1 in which any suitable material is used as a float to actuate the lever holding the pad used for restricting the inflow of liquid into the sleeve, an example being a suitable volume of plastic material impervious to and less dense than that of the liquid feed.
